(19) United States
(12) Patent Application Publication
(10) Pub. No.: US 2025/0376059 A1
(43) Pub. Date: Dec. 11, 2025

(54) ENERGY TRANSFER OUTLET SYSTEM FOR AN ENERGY TRANSFER SYSTEM

(71) Applicant: Caterpillar Inc., Peoria, IL (US)

(72) Inventors: Matthew SHERWOOD, Christchurch (NZ); Andrew William PAXSON, Tucson, AZ (US); Jeffery M. OTHMAN, Naperville, IL (US)

(73) Assignee: Caterpillar Inc., Peoria, IL (US)

(21) Appl. No.: 18/736,048

(22) Filed: Jun. 6, 2024

(51) Int. Cl. B60L 53/37; B60L 53/18; B60L 53/302

(52) U.S. Cl. CPC B60L 53/37; B60L 53/18; B60L 53/302; B60L 2200/40

(57) ABSTRACT

In some implementations, an energy transfer system includes a housing. The energy transfer system includes a robotic system that includes an end effector for enabling energy transfer, the robotic system being movable between an interior of the housing and an external environment. The energy transfer system includes an energy transfer dispenser system configured to output energy, the energy transfer dispenser system being located in the external environment. The energy transfer system includes one or more energy transfer cables coupled to the end effector. The energy transfer system includes an energy transfer outlet system mounted in the interior of the housing, the energy transfer outlet system enabling a connection between the one or more energy transfer cables and the energy transfer dispenser system.

### TECHNICAL FIELD

The present disclosure relates generally to an energy transfer system and, for example, to an energy transfer outlet system for the energy transfer system.

### BACKGROUND

Machines (e.g., that utilize a type of energy source other than fossil fuel, such as electricity, hydrogen, methanol, ammonia, or other sources of energy other than a fossil fuel), such as vehicles or other mobile machines, that are at least partially powered by on-board energy storage systems (e.g., batteries, hydrogen fuel cells, chemical storage components, among other examples) can be environmentally-friendly alternatives to machines powered by fossil fuels. However, in many cases, when a machine operates throughout the day, the on-board energy storage system needs to be replenished several times over the course of the day (e.g., at least five (5) times per day) to ensure that the machine has enough power to continuously operate. In some cases, a technician can connect one or more energy replenishing connectors to one or more receptacles of the machine (e.g., that are associated with an on-board energy storage system of the machine) to allow for the on-board energy storage system of the machine to be replenished. However, this manual process is subject to error (e.g., where a connector is not accurately inserted into a receptacle). This can result in a sub-optimal replenishment of the on-board energy storage system for the machine, such as in terms of an increased amount of time needed to replenish the energy for the machine and a decreased available energy level on-board the machine. Sub-optimal replenishment can impact operations of a machine, such as by reducing an amount of time that the machine is available to perform powered operations (e.g., as compared to an amount of time that the machine needs to be replenished with energy) and by reducing an amount of power that is available to perform the powered operations. Sub-optimal replenishment of the on-board energy storage system for the machine can, in some cases, also degrade the on-board energy storage system of the machine, which impacts a performance and/or an operable life of the on-board energy storage system, and of the machine.

In some examples, energy transfer between an energy transfer dispenser system and a machine may be accomplished using one or more energy transfer cables. An energy transfer cable may be a medium for transferring energy between the energy transfer dispenser system and a receptacle on the machine. However, some energy transfer cables have a large size and limited flexibility. For example, energy transfer cables designed for high-energy transfers may be bulky and rigid, resulting in the energy transfer cables being difficult to maneuver and/or bend. Maneuvering the energy transfer cables in tight spaces and/or through complex setups or systems is cumbersome and presents logistical and/or system design challenges.

Additionally, the energy transfer cables may be cooled to mitigate heat generated as a result of the high amount of energy transferred via the energy transfer cables. For example, the energy transfer cables may include a cooling system to regulate the temperature of the energy transfer cables (e.g., to reduce the likelihood of overheating and/or degraded energy transfer performance). In some examples, because of the difficulty associated with maneuvering the energy transfer cables, a longer energy transfer cable may be used in order to route the energy transfer cable to a desired location (e.g., because the longer energy transfer cable may be routed to avoid areas or obstacles that would otherwise be difficult to maneuver around due to the bulkiness and rigidness of the energy transfer cable). However, increasing the length of the energy transfer cable may reduce the energy transfer performance of the energy transfer cable (e.g., due to voltage drop for electrical energy transfer as an example). Additionally, heat dissipation becomes less efficient over longer distances, thereby resulting in the cooling system being unable to adequately mitigate the thermal load generated along the length of the energy transfer cable. This increases the risk of overheating of the energy transfer cable and/or degrades the performance of the energy transfer cable (e.g., that is operating at higher temperatures).

U.S. Pat. No. 11,400,822 (“the '822 patent”) discloses a system for charging commercial electric vehicles, including buses and trucks. The '822 patent discloses that the system can include a charging station that outputs a supply of relatively high voltage electrical power, and a cable suspension post having a support post and a suspension arm. The '822 patent discloses that at least a portion of a charging cable is electrically coupled to the charging station and suspended from the suspension arm and a charging connector can be free-hanging from the suspended portion of the charging cable, and therefore be swingingly displaceable into electrical engagement with a mating connector of the vehicle. Additionally, the '822 patent discloses that the suspension arm can be rotatably displaced relative to the support post and/or another portion of the suspension arm such that a vertical height and/or other position of the suspended arm can be adjusted.

While the '822 patent discloses a system for charging electric vehicles that includes a cable suspension post having a support post and a suspension arm, the '822 patent does not disclose any means to address the lack of maneuverability of energy transfer cables and/or cooling means for the energy transfer cables.

The energy transfer system and/or the energy transfer outlet system of the present disclosure solves one or more of the problems set forth above and/or other problems in the art.

### SUMMARY

An energy transfer system may include a housing; a robotic system that includes an end effector for enabling energy transfer, the robotic system being movable between an interior of the housing and an external environment; an energy transfer dispenser system configured to output energy, the energy transfer dispenser system being located in the external environment; one or more energy transfer cables coupled to the end effector; and an energy transfer outlet system mounted in the interior of the housing, the energy transfer outlet system enabling a connection between the one or more energy transfer cables and the energy transfer dispenser system.

An energy transfer outlet may include an outlet housing; and a bus, configured within the outlet housing, for enabling a connection between one or more separate lines of an external energy transfer dispenser and an internal energy transfer cable of a robotic system that enables energy transfer.

An energy transfer outlet system may include one or more energy transfer outlets mounted within a housing; one or more energy transfer cables coupled to respective energy transfer outlets of the one or more energy transfer outlets, the one or more energy transfer cables being configured to connect to a robotic system for energy transfer that is configured within the housing; and one or more energy transfer dispensers configured to output energy, the one or more energy transfer dispensers being coupled to respective energy transfer outlets of the one or more energy transfer outlets, and the one or more energy transfer dispensers being located in a region external to the housing.

### BRIEF DESCRIPTION OF THE DRAWINGS

FIG. 1 is a diagram of an example work machine described herein.

FIGS. 2A-2B are diagrams of an example energy transfer system.

FIG. 3 is a diagram of an example of an energy transfer outlet system of the energy transfer system.

FIG. 4 is a diagram of an example of the energy transfer outlet system of the energy transfer system.

FIG. 5 is a diagram of an example of the energy transfer outlet system of the energy transfer system.

FIG. 6 is a diagram of an example of an energy transfer outlet of the energy transfer outlet system.

FIG. 7 is a diagram of an example of an energy transfer outlet of the energy transfer outlet system.

FIG. 8 is a diagram of an example of the energy transfer outlet system.

### DETAILED DESCRIPTION

This disclosure relates to an energy transfer system that is configured to enable an energy transfer to a work machine, which is applicable to any work machine that is at least partially powered by a non-fossil-fuel-based energy storage system (e.g., energy other than fossil-fuel-based energy), such as a battery system. The work machine may be any type of machine configured to perform operations associated with an industry such as mining, construction, farming, transportation, or any other industry. Although some examples are described herein in associated with electrical energy transfer, the techniques, implementations, systems, devices, and/or components described herein may be similarly applicable for other types of energy transfer, such as hydrogen transfer, biofuel transfer, and/or gas transfer (e.g., propane, liquefied petroleum gas, compressed natural gas, liquefied natural gas, or other types of gas), among other examples.

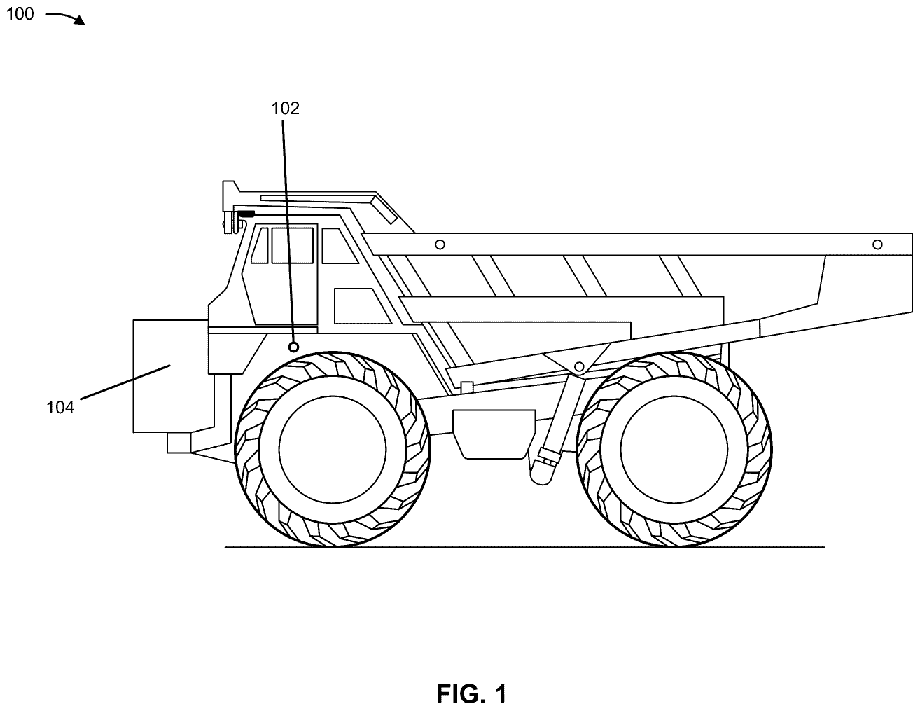

FIG. 1 is a diagram (e.g., a side-view) of an example work machine 100 described herein. The work machine 100 may be a mobile machine or vehicle, and may include a dump truck, a wheel loader, a hydraulic excavator, or another type of machine. Further, the work machine 100 may be a manned machine or an unmanned machine. The work machine 100 may be fully-autonomous, semi-autonomous, or remotely operated. As further shown in FIG. 1, the work machine 100 may include an energy storage system 102 (e.g., included within a chassis of the work machine 100) and a receptacle access point 104.

The work machine 100 may be configured to be at least partially powered by the energy storage system 102. That is, the work machine 100 may be a machine that utilizes electricity, hydrogen, methanol, ammonia, and/or other sources of energy other than a fossil fuel. As an example, the energy storage system 102 may include one or more batteries that store energy to be used to power one or more components of the work machine 100. For example, the work machine 100 may be a battery electric machine (BEM), a battery electric vehicle (BEV), a hybrid vehicle, a fuel cell and battery hybrid vehicle, or another machine that is at least partially powered by the energy storage system 102. The work machine 100 may include one or more electric engines, one or more electric motors, one or more electrical conversion systems, and/or other electrical components that are configured to convert and/or use energy, such as energy stored in the energy storage system 102, to cause overall movement of the work machine 100 across a work site and/or to cause movement of individual components or systems of the work machine 100.

The receptacle access point 104 provides an energy transfer interface (e.g., a wired energy transfer interface) for the energy storage system 102 and/or another fuel or energy storage of the work machine 100. For example, the receptacle access point 104 provides an energy transfer interface that can be physically connected to an energy transfer system (e.g., the energy transfer system 200 described herein) to allow an energy transfer from the energy transfer system to the energy storage system 102 (or vice versa) or other fuel or energy storage.

As indicated above, FIG. 1 is provided as an example. Other examples may differ from what is described in connection with FIG. 1.

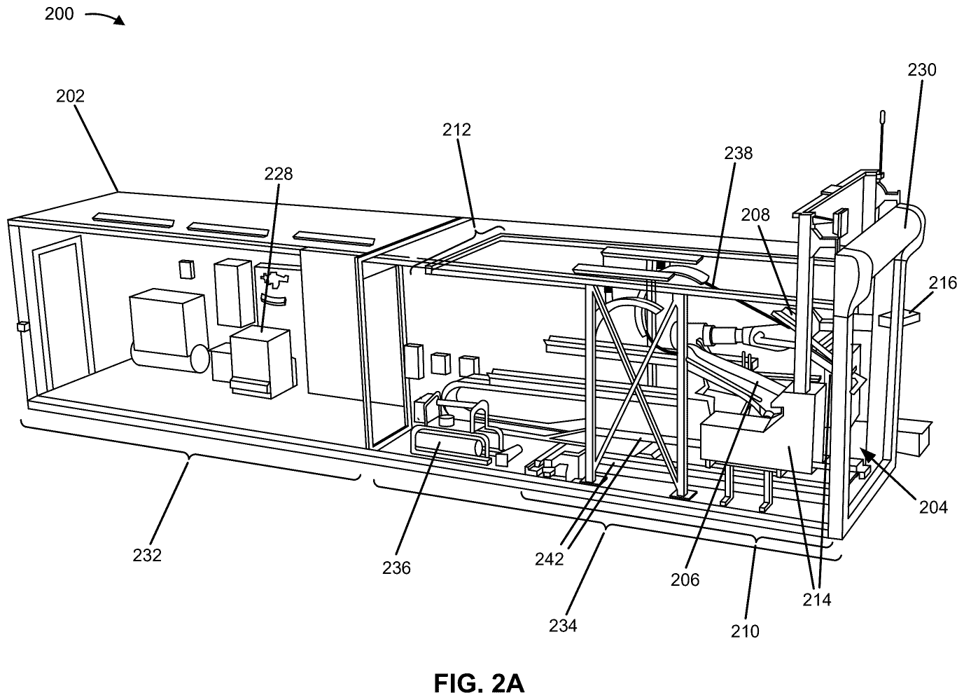

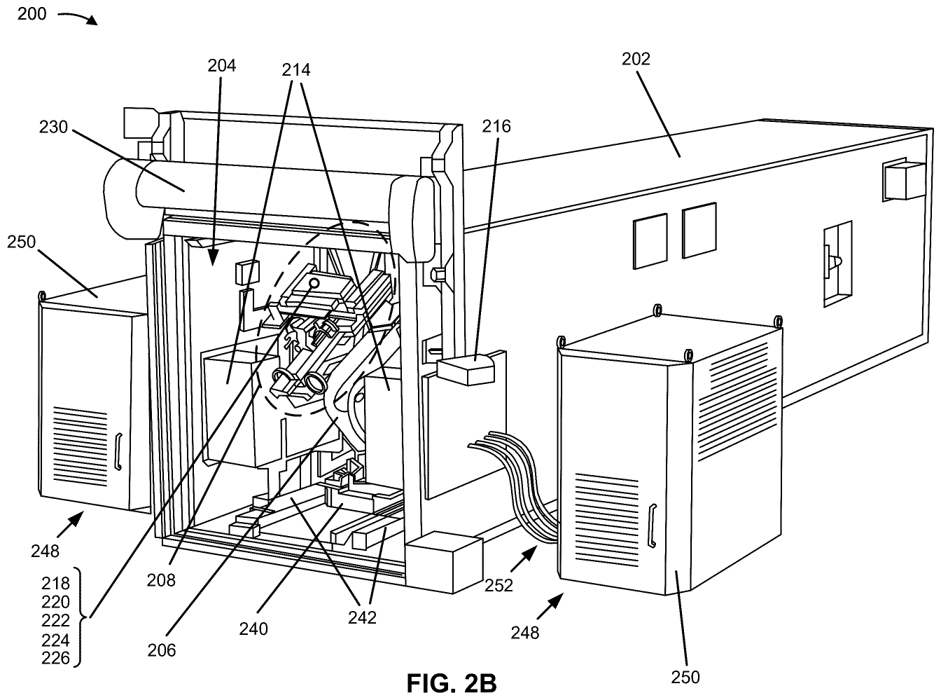

FIGS. 2A-2B are diagrams of an example energy transfer system 200. The energy transfer system 200 is configured to enable an energy transfer to and/or from the work machine 100 (e.g., to and/or from the energy storage system 102 of the work machine 100). In some implementations, the energy transfer system 200 is configured to autonomously enable the energy transfer (e.g., as further described herein), such as without any interaction with a human technician. However, other implementations include a human technician interacting with the energy transfer system 200 and, thus, the term “energy transfer system” includes any energy transfer system that is at least semi-autonomous (e.g., includes at least one autonomously controlled or operated system or component). FIG. 2A shows a side (cut-away) view of the energy transfer system 200, and FIG. 2B shows a front-angled view of the energy transfer system 200.

As shown in FIGS. 2A-2B, the energy transfer system 200 may include a housing 202 that includes a portal 204 at an end of the housing; a robotic system 206 that includes an end effector 208; a slide system 210; a cable management system 212; an energy transfer outlet system 214; a first camera system 216; a second camera system 218; a door opening system 220; a connector retention system 222; a connector protection system 224; a door closing system 226; and/or one or more controllers 228.

The housing 202 includes a metal, or other hard and/or weather resistant material, and may have a rectangular prism shape and/or other shapes. The housing 202 may include the portal 204 at an end of the housing 202 (e.g., instead of one of the short sides of the housing 202). The energy transfer system 200 may include a housing door 230 that is configured to cover the portal 204 when closed, and to uncover the portal 204 when open. For example, the housing door 230 may be a retractable door. The housing door 230, when closed, may protect an interior of the housing 202, such by preventing dirt, rocks, construction debris, waste matter, moisture, or other material (e.g., present at a work site at which the work machine 100 is operating) from accessing interior of the housing 202.

As shown in FIG. 2A, the interior of the housing 202 may be divided into a first interior portion 232 of the housing 202 and a second interior portion 234 of the housing 202 (e.g., that is separated by a wall, a door, or another separator). The first interior portion 232 of the housing 202 may include the one or more controllers 228 and/or one or more other electrical components, one or more pneumatic components, and/or one or more other communication components, among other examples, that enable operation of the systems and components included in the second interior portion 234 of the housing 202.

The second interior portion 234 of the housing 202 may include the slide system 210, the cable management system 212, and the energy transfer outlet system 214. The second interior portion 234 may also include additional systems and/or components for enabling operation of the robotic system 206 and/or an energy transfer operation, such as a pressure washer system 236 and one or more energy transfer cables 238 (e.g., that are configured to transmit energy to and/or from one or more plugs of the end effector 208). As shown in FIG. 2A, the second interior portion 234 may be associated with the end of the housing 202 that includes the portal 204. The slide system 210 is configured to move the robotic system 206, via the portal 204 of the housing 202, between an interior of the housing 202 (e.g., the second interior portion 234 of the housing 202) and an external environment (e.g., that surrounds the housing 202, such as at a work site). The slide system 210 may include a mount 240 for connecting to the robotic system 206 (e.g., for holding the robotic system 206 as the robotic system is moved by the slide system 210) and a slide apparatus 242 for moving the robotic system 206.

As shown in FIGS. 2A-2B, the first camera system 216 may be mounted on an exterior (e.g., an exterior side) of the housing 202. The first camera system 216 may include one or more cameras or other image capturing devices. The second camera system 218 is configured to obtain second image data associated with the access mechanism of the receptacle access point 104 and/or of one or more receptacles of the work machine 100. The door opening system 220 is configured to open an access door of the receptacle access point 104 (e.g., based on the location of an access mechanism of the receptacle access point 104 identified by the one or more controllers 228). The door opening system 220 may include a manipulation system for manipulating the access mechanism of the receptacle access point 104 to allow the access door to open.

The energy transfer outlet system 214 is a dispenser system for one or more energy transfer cables 238 coupled to the end effector 208. For example, the energy transfer outlet system 214 includes outlets for respective energy transfer cables 238. The energy transfer outlet system 214 is mounted or configured in the interior of the housing 202. The energy transfer outlet system 214 is configured for enabling connection between the one or more energy transfer cables 238 and an external energy transfer dispenser system 248 (e.g., that is not included in the energy transfer system 200). The energy transfer dispenser system 248 may be, for example, configured as a high-capacity external transfer dispenser system that transmits and distributes electrical power at a scale of millions of watts (megawatts) (e.g., the energy transfer dispenser system 248 may include one or more megawatt dispensers). In other examples, the energy transfer dispenser system 248 may be another type of energy transfer dispenser system, such as a hydrogen fuel dispenser, and/or a biofuel dispenser, among other examples. Accordingly, the energy transfer dispenser system 248 may provide energy to the one or more energy transfer cables 238, and thus to plugs of the end effector 208 via the energy transfer outlet system 214.

The energy transfer dispenser system 248 includes one or more energy transfer dispensers 250 (shown as two energy transfer dispensers 250 in FIG. 2B as an example), which may also be referred to as energy dispensers. Each energy transfer dispenser 250 is configured to output and/or receive energy. The energy transfer dispenser system 248 may include one or more lines 252 extending from each energy transfer dispenser 250. The one or more lines 252 include energy lines (e.g., for outputting energy from the energy transfer dispenser 250), and/or communication lines (e.g., for enabling communication to and/or from a component of the energy transfer dispenser 250), among other examples. For example, if the energy transfer dispenser 250 is configured to output electrical energy, then the energy lines may be direct current (DC) lines. The one or more lines 252 may include multiple and/or separate lines, as shown in FIG. 2B. The one or more lines 252 are rigid lines (e.g., may include a rigid exterior that results in the one or more lines 252 having a high rigidity level).

The energy transfer outlet system 214, by being positioned within the interior of the housing 202 (e.g., within the second interior portion 234 of the housing 202), allows a length of the one or more energy transfer cables 238 to be reduced (e.g., as compared to energy transfer cables that would need to be externally routed to the energy transfer dispenser system 248), which mitigates the likelihood of damage to the one or more energy transfer cables 238 (e.g., due to bending, tangling, kinking, or other issues). For example, because the energy transfer cables 238 may be bulky, rigid, and/or otherwise difficult to bend, positioning the energy transfer outlet system 214 within the interior of the housing 202 reduces complexity of routing the energy transfer cables 238 and reduces the likelihood that the energy transfer cables 238 are bent to a radius that is less than a bend radius for the energy transfer cables 238 (e.g., the bend radius may be a permitted (a minimum) radius an energy transfer cable 238 can be bent without risking damage to the integrity or performance of the energy transfer cable 238). Additionally, by allowing the length of the energy transfer cables 238 to be reduced, the configuration of the energy transfer outlet system 214 enables improved cooling performance for the energy transfer cables 238. Further, the energy transfer outlet system 214, by being a separate system that is not integrated into the energy transfer dispenser system 248, allows the energy transfer dispenser system 248 to remain external to the energy transfer system 200. This enables the positioning and operation of the other systems and components of the energy transfer system 200 in a confined area, such as the interior of the housing 202.

As indicated above, FIGS. 2A-2B are provided as an example. Other examples may differ from what is described in connection with FIGS. 2A-2B.

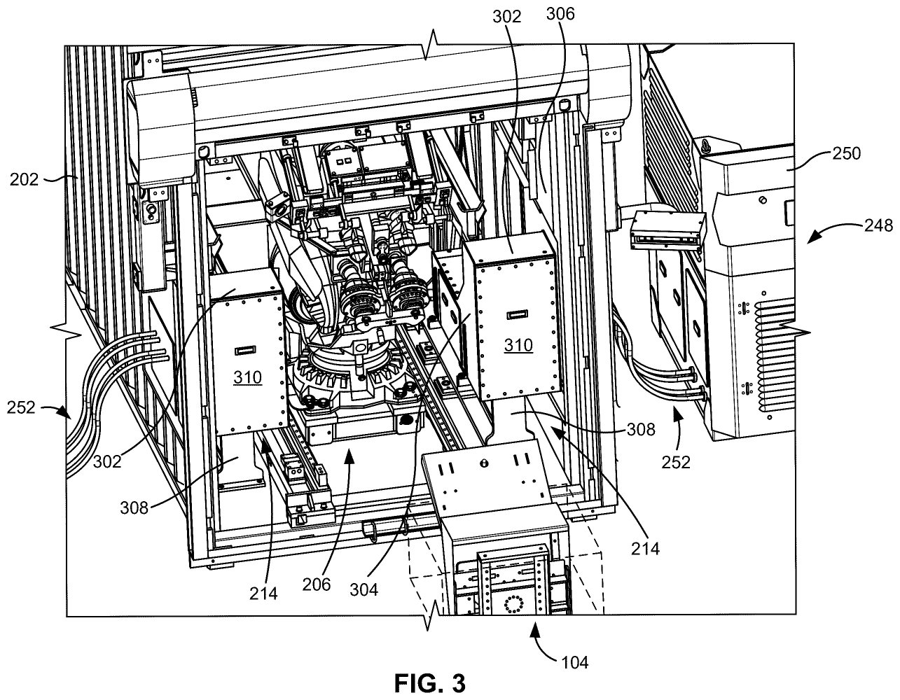

FIG. 3 is a diagram of an example 300 of an energy transfer outlet system 214 of the energy transfer system 200.

As shown in FIG. 3, the energy transfer outlet system 214 includes one more energy transfer outlets 302 (shown as two energy transfer outlets 302 in FIG. 3). For example, the energy transfer outlet system 214 may include energy transfer outlets 302 for respective energy transfer cables 238 of the energy transfer system 200 (e.g., each energy transfer cable 238 may extend from an outlet from separate energy transfer outlets 302). An energy transfer outlet 302 includes an outlet housing 304. One or more components of the energy transfer outlet 302 may be housed or configured inside the outlet housing 304. For example, a junction or connection (e.g., a bus) enables communicative coupling and/or energy transfer coupling between an energy transfer cable 238 and an energy transfer dispenser system 248. The energy transfer outlet system enables a connection between the one or more energy transfer cables 238 and the energy transfer dispenser system 248 via respective energy transfer outlets 302. For example, one or more lines 252 of the energy transfer dispenser system 248 may extend from an energy transfer dispenser 250 into the interior of the housing 202 and into the outlet housing 304 of an energy transfer outlet 302.

The energy transfer outlet system 214 is mounted in the interior of the housing 202. For example, the one more energy transfer outlets 302 may be mounted, placed, or otherwise configured in the one more energy transfer outlets 302 (e.g., in the second interior portion 234 of the housing 202). The one more energy transfer outlets 302 are mounted, placed, or otherwise configured proximate to an interior wall 306 of the housing 202. For example, as shown in FIG. 3, a first energy transfer outlet 302 is mounted, placed, or otherwise configured proximate to a first interior wall 306 of the housing 202 and a second energy transfer outlet 302 is mounted, placed, or otherwise configured proximate to a second interior wall 306 of the housing 202. An energy transfer outlet 302 may be mounted or connected to an interior wall 306 (e.g., via one or more mechanical connections, bolts, screws, magnets, or other means). Additionally, or alternatively, the energy transfer outlet 302 may be configured proximate to an interior wall 306 via a mounting structure 308. For example, the energy transfer outlet 302 may be connected or coupled (e.g., via one or more mechanical connections, bolts, screws, magnets, or other means) to the mounting structure 308. The mounting structure 308 may position the energy transfer outlet 302 such that a distance between the energy transfer outlet 302 and the interior wall 306 satisfies a distance threshold. The mounting structure 308 may position the energy transfer outlet 302 at a cable height. The cable height is a height that enables an energy transfer cable 238 to be routed to the end effector 208 (e.g., via the cable management system 212) without bending the energy transfer cable 238 to a radius that is less than a bend radius of the energy transfer cable 238.

An energy transfer outlet 302 includes an access panel 310. The access panel 310 is removably attached to the outlet housing 304, such as via a mechanical connection (e.g., one or more bolts, one or more screws, one or more clips, one or more latches, one or more magnets, or another mechanical connection). When the access panel 310 is removed from the outlet housing 304, an aperture in the outlet housing 304 is exposed. The aperture enables access to the interior of the outlet housing 304. This enables components internal to the outlet housing 304 to be accessed, evaluated, repaired, and/or replaced, among other examples, without the energy transfer outlet 302 being uninstalled or removed from the housing 202. For example, the aperture in the outlet housing 304 enables an energy transfer cable 238 to be replaced without the energy transfer outlet 302 being uninstalled or removed from the housing 202.

As indicated above, FIG. 3 is provided as an example. Other examples may differ from what is described in connection with FIG. 3.

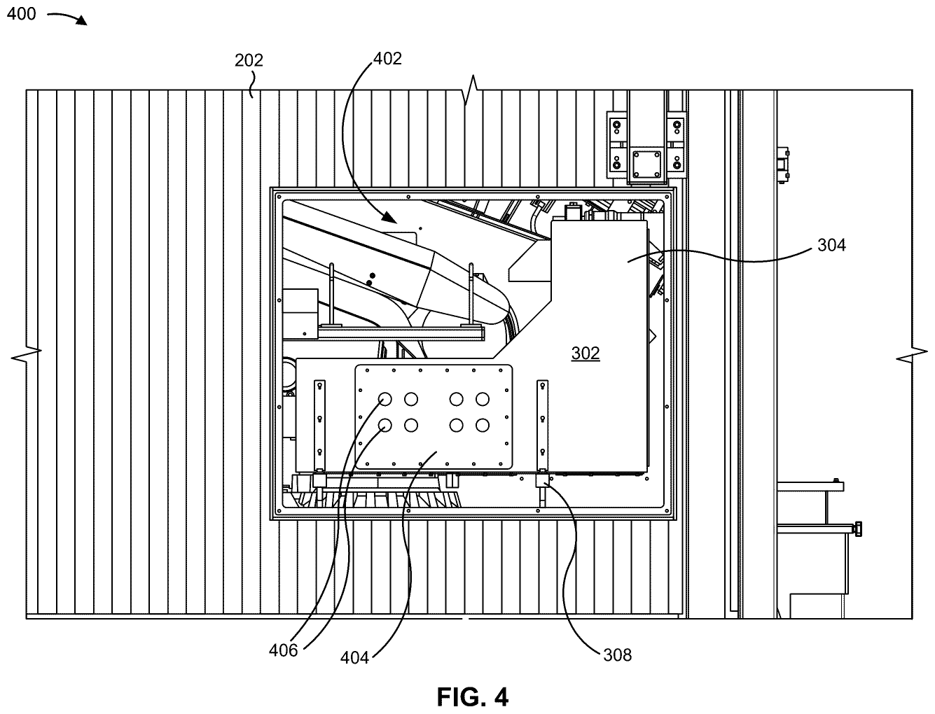

FIG. 4 is a diagram of an example 400 of the energy transfer outlet system 214 of the energy transfer system 200.

As shown in FIG. 4, the housing 202 may include one or more apertures 402. For example, the housing 202 may include apertures 402 on each side of the housing 202. The aperture(s) 402 may enable access to the interior of the housing 202 from an external environment (e.g., external to the housing 202). The aperture(s) 402 may be positioned at locations corresponding to respective energy transfer outlets 302 of the energy transfer outlet system 214.

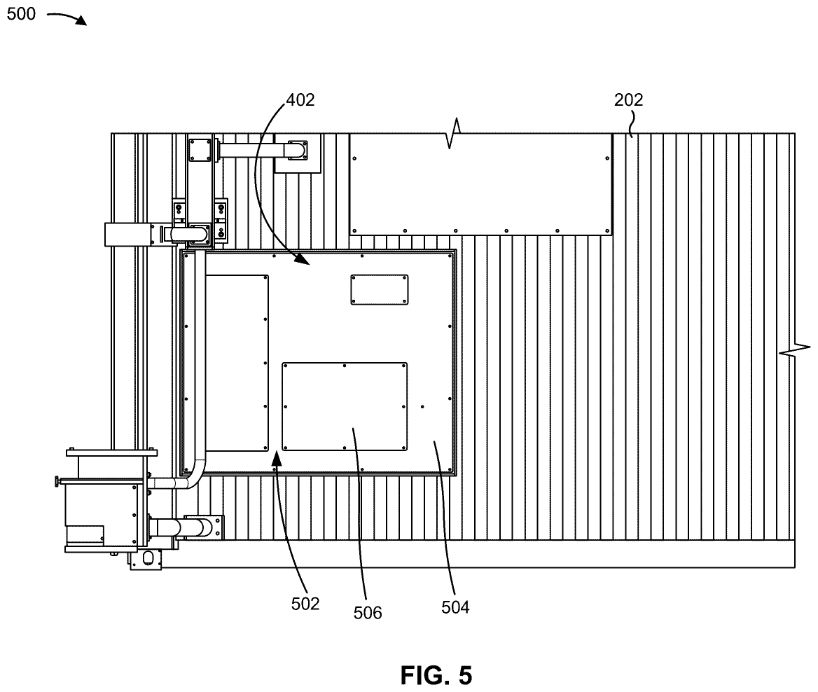

For example, the one or more energy transfer outlets 302 are mounted proximate to corresponding apertures 402 in the housing 202. The mounting structure 308 may position the energy transfer outlet 302 such that the energy transfer outlet 302 (e.g., mounted or positioned in the interior of the housing 202) is accessible from the external environment. This reduces the complexity associated with maintaining, inspecting, installing, and/or uninstalling the energy transfer outlet(s) 302. For example, the interior of the housing 202 may have limited space due to the quantity of components of the energy transfer system 200 and the confined space within the interior of the housing 202. The aperture(s) 402 provide direct access to the location at which an energy transfer outlet 302 is to be mounted or installed (e.g., without moving, uninstalling, or impacting other components of the energy transfer system 200). The aperture(s) 402 may be sealed or otherwise blocked by one or more panels, as depicted and described in more detail in connection with FIG. 5.

The energy transfer outlet 302 includes one or more line access panels 404. The line access panels 404 include one or more apertures 406. The one or more apertures 406 are configured to accept the line(s) 252 of the energy transfer dispenser system 248. For example, the line(s) 252 are routed through respective apertures 406 into the interior of the outlet housing 304. In some examples, the energy transfer outlet 302 includes two corresponding (e.g., identical) access line access panels 404 on each side of the outlet house 304, as described in more detail elsewhere herein.

As indicated above, FIG. 4 is provided as an example. Other examples may differ from what is described in connection with FIG. 4.

FIG. 5 is a diagram of an example 500 of the energy transfer outlet system 214 of the energy transfer system 200. As shown in FIG. 5, the housing 202 of the energy transfer system 200 includes one or more access panels 502. The one or more access panels 502 are removably attached to the housing 202, such as via one or more mechanical connections, one or more bolts, one or more screws, and/or one or more magnets, among other examples. The one or more access panels 502 may block, seal, or otherwise prevent access to the interior of the housing 202 via an aperture 402. The one or more access panels 502 may include an aperture panel 504 configured to engage with (e.g., block or seal) an aperture 402. The one or more access panels 502 may include a line access panel 506. The line access panel 506, when removed, may enable access to the line access panel 404 of an energy transfer outlet 302 (e.g., when the aperture panel 504 is installed).

As indicated above, FIG. 5 is provided as an example. Other examples may differ from what is described in connection with FIG. 5.

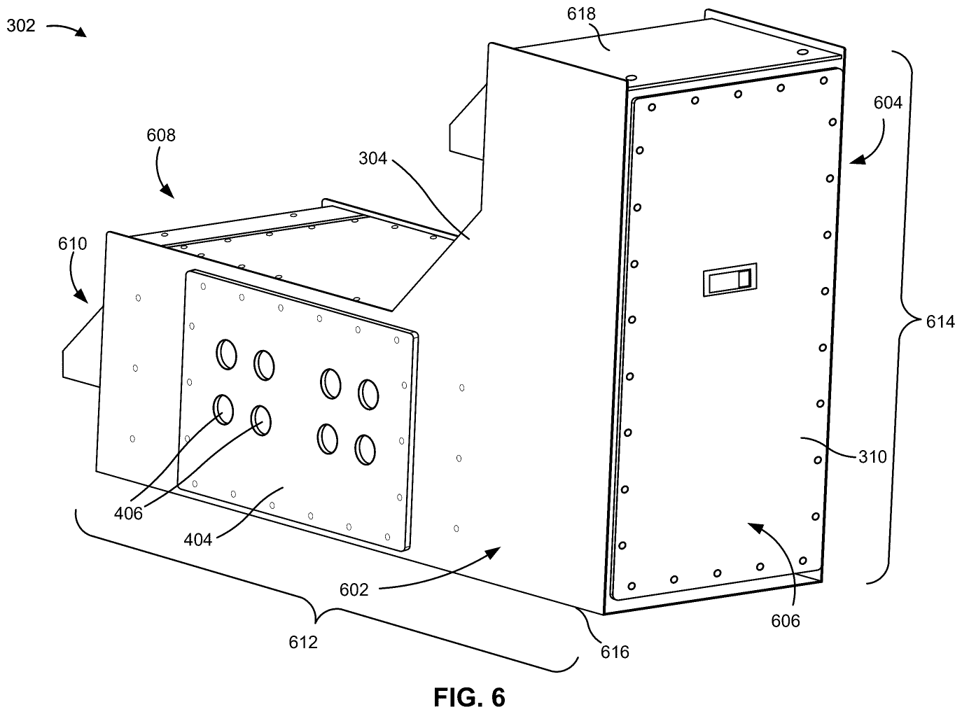

FIG. 6 is a diagram of an example of an energy transfer outlet 302 of the energy transfer outlet system 214.

The outlet housing 304 includes a first side 602 and a second side 604. Additionally, the outlet housing 304 includes a front side 606 and a rear side 608. The first side 602 includes the line access panel 404 and the one or more apertures 406. In some examples, the second side 604 may also include a line access panel 404 and one or more apertures 406 in a similar manner as depicted in FIG. 6. For example, the first side and the second side include corresponding apertures 406 configured to accept the one or more separate lines 252 of the external energy transfer dispenser 250. For example, the first side 602 and the second side 604 each include corresponding apertures 406 that are configured to accept respective energy lines 252. In this way, the energy transfer outlet 302 may be configured or installed on either side of the interior of the housing 202, providing improved flexibility for the arrangement of the components of the energy transfer system 200 within the housing 202.

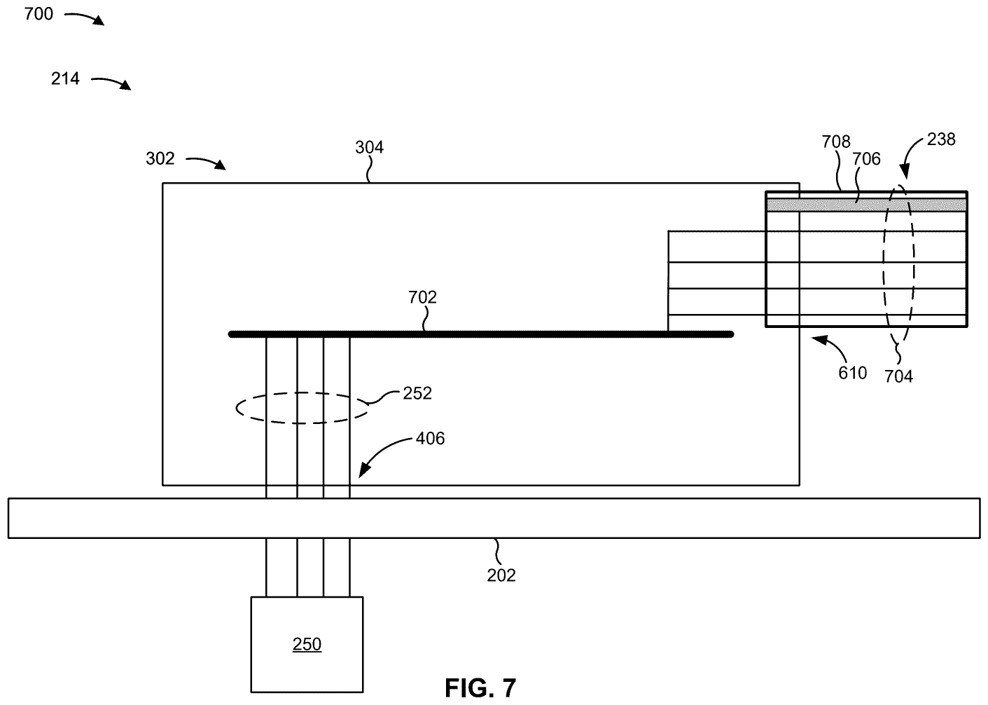

The front side 606 includes the access panel 310 that is configured to enable access to an interior of the outlet housing 304. For example, the access panel 310 enables access to a bus associated with connecting the lines 252 to an energy transfer cable 238. The bus is depicted and described in more detail in connection with FIG. 7. The rear side 608 includes an outlet 610. The outlet 610 is an opening or aperture via which an energy transfer cable 238 can extend into the interior of the outlet housing 304.

The outlet housing 304 has an orthogonal shape or configuration (e.g., an “L” shape or configuration). For example, the outlet housing 304 has a first section 612 extending between the front side 606 and the rear side 608. The outlet housing 304 has a second section 614 extending between a bottom side 616 and a top side 618 of the outlet housing 304. The first section 612 and the second section 614 may be perpendicular, forming an “L” shape or configuration.

As indicated above, FIG. 6 is provided as an example. Other examples may differ from what is described in connection with FIG. 6.

FIG. 7 is a diagram of an example of an energy transfer outlet 302 of the energy transfer outlet system 214. FIG. 7 depicts one or more components in the interior of the outlet housing 304 of an energy transfer outlet 302.

As shown in FIG. 7, the energy transfer outlet 302 includes a bus 702. The bus 702 enables connection between the one or more lines 252 and the energy transfer cable 238 (e.g., one or more lines 704 internal to the energy transfer cable 238). The bus 702 may be referred to as a bus bar. The bus 702 may include one or more components that enable wired and/or wireless communication among the components of the energy transfer outlet 302, the one or more lines 252, and the energy transfer cable 238. The bus 702 may couple together two or more components of FIG. 7, such as via operative coupling, communicative coupling, electronic coupling, fluid coupling, hydraulic coupling, pneumatic coupling, a fluid interconnection coupling, and/or electric coupling, among other examples. For example, the bus 702 may include an electrical connection (e.g., a wire, a trace, and/or a lead) and/or a wireless bus.

The bus 702 is configured to enable one or more energy transfer connections and one or more communication lines connected between the energy transfer cable 238 (e.g., internal to the energy transfer system 200) and the energy transfer dispenser 250 (e.g., external to the housing 202). The bus is configured within the outlet housing 304 of the energy transfer outlet 302. The bus 702 couples the energy lines from the energy transfer dispenser 250 (e.g., separated energy lines) and energy lines included inside of an energy transfer cable 238.

As shown in FIG. 7, an energy transfer cable 238 includes one or more lines 704. The one or more lines 704 include a first one or more energy lines (e.g., DC lines and/or ground lines, or other types of energy transfer lines), one or more coolant lines 706, and/or one or more communication lines. The one or more lines 704 (e.g., the one or more energy lines, the one or more coolant lines, and/or the first one or more communication lines) are configured within the energy transfer cable 238 (e.g., within a cable casing 708). As described elsewhere herein, the energy transfer cable 238 is a cooling-equipped energy transfer cable (e.g., via coolant within the one or more coolant lines 706).

As described herein, the energy transfer dispenser 250 includes one or more lines 252 (e.g., one or more energy lines for outputting energy from the energy transfer dispenser, and/or one or more communication lines) extending from the energy transfer dispenser 250. The line(s) 252 may be multiple separate lines extending from the energy transfer dispenser 250 (e.g., that is external to the housing 202) to an interior of the housing 202. The bus 702 enables an energy transfer coupling of energy lines from the one or more lines 252 and the one or more lines 704. Additionally, the bus 702 enables communicative coupling between communication lines from the one or more lines 252 and the one or more lines 704.

As a result, the energy transfer cable 238 may begin (e.g., may be output from) the interior of the outlet housing 304 (e.g., rather than beginning at the energy transfer dispenser 250). This reduces the length of the energy transfer cable 238 and/or enables the energy transfer cable 238 to begin in the interior of the housing 202 (e.g., without the energy transfer dispenser 250 being in the interior of the housing and without routing the energy transfer cable 238 to the external environment outside of the housing 202).

As indicated above, FIG. 7 is provided as an example. Other examples may differ from what is described in connection with FIG. 7.

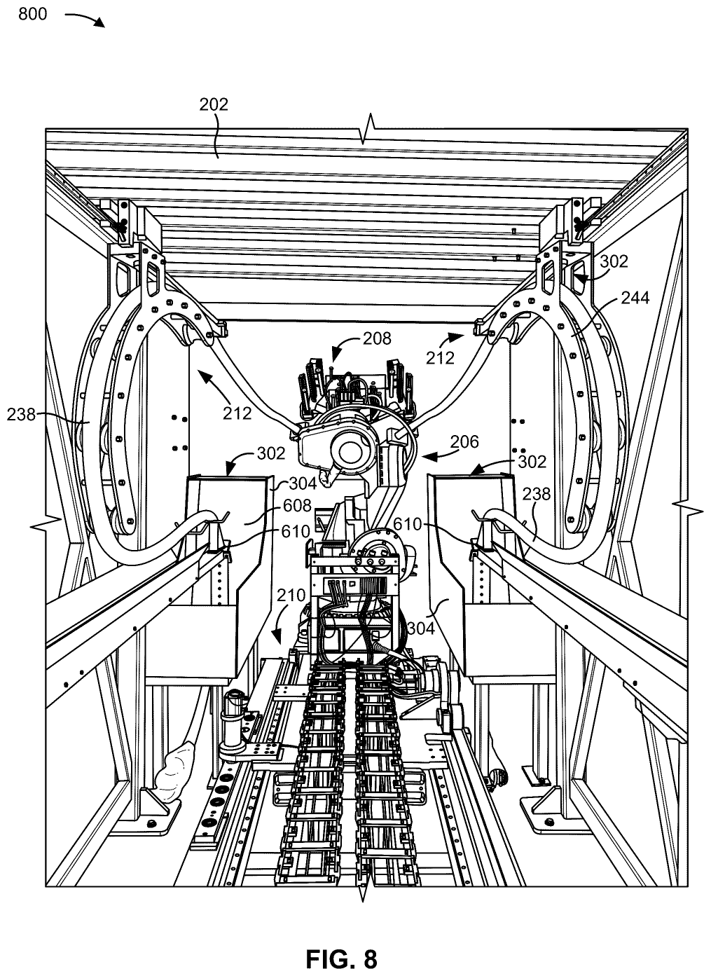

FIG. 8 is a diagram of an example of the energy transfer outlet system 214. The view shown in FIG. 8 may be from the interior of the housing 202, such as from behind the robotic system 206 looking out through the portal 204.

As shown in FIG. 8, an energy transfer cable 238 is output from an energy transfer outlet 302. For example, the energy transfer cable 238 extends from the outlet 610 of the energy transfer outlet 302. The energy transfer cable 238 is routed to the end effector 208 of the robotic system 206 via the slide system 210. The reduces the complexity associated with routing the energy transfer cable 238 for the energy transfer system 200, reduces the length of the energy transfer cable 238, and/or reduces the likelihood of damage to the energy transfer cable 238 that may otherwise be caused by the energy transfer cable 238 being bent at a radius that is less than a bend radius of the energy transfer cable 238, among other examples.

As indicated above, FIG. 8 is provided as an example. Other examples may differ from what is described in connection with FIG. 8.

### INDUSTRIAL APPLICABILITY

In some examples, energy transfer between an energy transfer dispenser system and a machine may be accomplished using one or more energy transfer cables. However, some energy transfer cables have a large size and limit flexibility. For example, energy transfer cables designed for high-energy transfers may be bulky and rigid, resulting in the energy transfer cables being difficult to maneuver and/or bend. Maneuvering the energy transfer cables in tight spaces and/or through complex setups or systems is cumbersome and presents logistical and/or system design challenges. Additionally, the energy transfer cables may be cooled to mitigate heat generated as a result of the high amount of energy transferred via the energy transfer cables. In some examples, because of the difficulty associated with maneuvering the energy transfer cables, a longer energy transfer cable may be used to route the energy transfer cable to a desired location (e.g., because the longer energy transfer cable may be routed to avoid areas or obstacles that would otherwise be difficult to maneuver around due to the bulkiness and rigidness of the energy transfer cable). However, increasing the length of the energy transfer cable may reduce the energy transfer performance of the energy transfer cable (e.g., due to voltage drop for electrical energy transfer as an example). Additionally, heat dissipation becomes less efficient over longer distances, thereby resulting in the cooling system being unable to adequately mitigate the thermal load generated along the length of the energy transfer cable. This increases the risk of overheating of the energy transfer cable and/or degrades the performance of the energy transfer cable (e.g., that is operating at higher temperatures).

The energy transfer system and/or the energy transfer outlet system disclosed herein enables reduced complexity and improved performance for routing energy transfer cables as part of the energy transfer system. For example, the energy transfer outlet system includes one or more energy transfer outlets mounted, configured, or placed within a housing of the energy transfer system (e.g., in a “sidecar” configuration). The energy transfer system may transfer energy via an energy transfer dispenser system that is located in an external environment (e.g., external to the housing of the energy transfer system). An energy transfer outlet of the energy transfer outlet system enables a connection or coupling between one or more lines (e.g., energy transfer lines and/or communication lines) extending from an energy transfer dispenser and an energy transfer cable that is coupled to an end effector of a robotic system of the energy transfer system. For example, an origin point or source point for the energy transfer cable is the energy transfer outlet (e.g., that is positioned within the housing of the energy transfer system).

The energy transfer outlet system, by being positioned within the interior of the housing, allows a length of the one or more energy transfer cables to be reduced (e.g., as compared to energy transfer cables that would need to be externally routed to the energy transfer dispenser system), which mitigates the likelihood of damage to the one or more energy transfer cables (e.g., due to bending, tangling, kinking, or other issues). For example, because the energy transfer cables may be bulky, rigid, and/or otherwise difficult to bend, positioning the energy transfer outlet system within the interior of the housing reduces complexity of routing the energy transfer cables and reduces the likelihood that the energy transfer cables are bent to a radius that is less than a bend radius for the energy transfer cables. Additionally, by allowing the length of the energy transfer cables to be reduced, the configuration of the energy transfer outlet system enables improved cooling performance for the energy transfer cables. Further, the energy transfer outlet system, by being a separate system that is not integrated into the energy transfer dispenser system, allows the energy transfer dispenser system to remain external to the energy transfer system. This enables the positioning and operation of the other systems and components of the energy transfer system in a confined area, such as the interior of the housing.

What is claimed is:

1. An energy transfer system, comprising:
a housing;
a robotic system that includes an end effector for enabling energy transfer, the robotic system being movable between an interior of the housing and an external environment;
an energy transfer dispenser system configured to output energy, the energy transfer dispenser system being located in the external environment;
one or more energy transfer cables coupled to the end effector; and
an energy transfer outlet system mounted in the interior of the housing, the energy transfer outlet system enabling a connection between the one or more energy transfer cables and the energy transfer dispenser system.

2. The energy transfer system of claim 1, wherein the energy transfer dispenser system includes one or more energy dispensers,
wherein the energy transfer outlet system includes one or more energy transfer outlets connected to respective energy dispensers of the one or more energy dispensers, and
wherein the one or more energy transfer outlets are connected to respective energy transfer cables of the one or more energy transfer cables.

3. The energy transfer system of claim 1, wherein the one or more energy transfer cables are cooling-equipped energy transfer cables.

4. The energy transfer system of claim 1, wherein an energy transfer cable, of the one or more energy transfer cables, includes a first one or more energy lines, one or more coolant lines, and one or more communication lines, wherein the first one or more energy lines, the one or more coolant lines, and the one or more communication lines are configured within the energy transfer cable,
wherein the energy transfer dispenser system includes an energy transfer dispenser that includes a second one or more energy lines for outputting energy from the energy transfer dispenser, and
wherein the energy transfer outlet system includes an energy transfer outlet that includes a bus that couples the first one or more energy lines and the second one or more energy lines.

5. The energy transfer system of claim 4, wherein the second one or more energy lines are separate lines extending from the energy transfer dispenser in the external environment to the interior of the housing.

6. The energy transfer system of claim 4, wherein the bus is configured within an outlet housing of the energy transfer outlet.

7. The energy transfer system of claim 1, wherein the housing includes one or more apertures at locations corresponding to respective energy transfer outlets of the energy transfer outlet system.

8. The energy transfer system of claim 1, wherein the energy transfer dispenser system includes one or more megawatt dispensers.

9. An energy transfer outlet, comprising:
an outlet housing; and
a bus, configured within the outlet housing, for enabling a connection between one or more separate lines of an external energy transfer dispenser and an internal energy transfer cable of a robotic system that enables energy transfer.

10. The energy transfer outlet of claim 9, wherein the outlet housing includes a first side and a second side, and
wherein the first side and the second side include corresponding apertures configured to accept the one or more separate lines of the external energy transfer dispenser.

11. The energy transfer outlet of claim 9, wherein the outlet housing includes a front side, and
wherein the front side includes an access panel configured to enable access to the bus.

12. The energy transfer outlet of claim 9, wherein the bus is configured to enable one or more energy transfer connections and one or more communication lines connected between the internal energy transfer cable and the external energy transfer dispenser.

13. The energy transfer outlet of claim 9, wherein the robotic system is configured within a housing, and
wherein the energy transfer outlet is configured to be mounted within the housing.

14. An energy transfer outlet system, comprising:
one or more energy transfer outlets mounted within a housing;
one or more energy transfer cables coupled to respective energy transfer outlets of the one or more energy transfer outlets, the one or more energy transfer cables being configured to connect to a robotic system for energy transfer that is configured within the housing; and
one or more energy transfer dispensers configured to output energy, the one or more energy transfer dispensers being coupled to respective energy transfer outlets of the one or more energy transfer outlets, and the one or more energy transfer dispensers being located in a region external to the housing.

15. The energy transfer outlet system of claim 14, wherein an energy transfer cable, of the one or more energy transfer cables, includes a first one or more energy lines, one or more coolant lines, and a first one or more communication lines, wherein the first one or more energy lines, the one or more coolant lines, and the first one or more communication lines are configured within the energy transfer cable,
wherein an energy transfer dispenser, of the one or more energy transfer dispensers, includes a second one or more energy lines for outputting energy from the energy transfer dispenser and a second one or more communication lines, and
wherein an energy transfer outlet, of the one or more energy transfer outlets, includes a bus that couples the first one or more energy lines and the second one or more energy lines and that couples the first one or more communication lines and the second one or more communication lines.

16. The energy transfer outlet system of claim 15, wherein the second one or more energy lines are separate lines extending from the energy transfer dispenser external to the housing to an interior of the housing.

17. The energy transfer outlet system of claim 15, wherein the bus is configured within an outlet housing of the energy transfer outlet.

18. The energy transfer outlet system of claim 17, wherein the outlet housing includes a first side and a second side, and
wherein the first side and the second side each include corresponding apertures that are configured to accept respective energy lines of the second one or more energy lines.

19. The energy transfer outlet system of claim 14, wherein the one or more energy transfer cables are cooling-equipped energy transfer cables.

20. The energy transfer outlet system of claim 14, wherein the one or more energy transfer outlets are mounted proximate to corresponding apertures in the housing.
